(19) United States
(12) Patent Application Publication
(10) Pub. No.: US 2019/0353494 A1
(43) Pub. Date: Nov. 21, 2019

(54) ROUTE RECOMMENDATION SYSTEM FOR FIELD SERVICE TECHNICIANS

(71) Applicant: OTIS ELEVATOR COMPANY, Farmington, CT (US)

(72) Inventors: Yiqing Lin, Glastonbury, CT (US); Teems E. Lovett, Glastonbury, CT (US); Mark Antunes, Winnipeg (CA)

(21) Appl. No.: 15/981,966

(22) Filed: May 17, 2018

(51) Int. Cl. G01C 21/34; G01C 21/36; G06Q 10/06

(52) U.S. Cl. CPC G01C 21/3484; G01C 21/3492; G06Q 10/06311; G01C 21/3676; G01C 21/343

(57) ABSTRACT

A system for providing route recommendations for field service technicians is provided. The system includes a processor for performing operations that include identifying a current geographic location of a service technician and receiving a list of tasks for the service technician. A plurality of route options are generated for the service technician based at least in part on the list of tasks and the current geographic location of the service technician. Each of the plurality of route options includes a geographic location of at least one of the tasks in the list of tasks. The route options are output.

### BACKGROUND

The subject matter disclosed herein generally relates to the field of route recommendation, and more particularly to an apparatus and method for providing a route recommendation system for field service technicians.

Field service technicians are responsible for performing service at geographically dispersed customer locations. The service tasks may have various levels of priorities and due dates, or deadlines. Some tasks are scheduled and known to technicians well in advance, such as a week or more ahead of a scheduled service. Other tasks are unscheduled and only known to a technician when the service is required. A challenge currently faced by service technicians is how to most efficiently and timely perform a wide variety of service tasks, both scheduled and unscheduled, across multiple geographic locations.

### BRIEF SUMMARY

According to another embodiment a system of providing route recommendations for field service technicians is provided. The system includes a processor and a memory including computer-executable instructions that, when executed by the processor, cause the processor to perform operations. The operations include identifying a current geographic location of a service technician and receiving a list of tasks for the service technician. The list of tasks includes, for each of the tasks, a geographic location of the task, a deadline of the task, and a priority of the task. A plurality of route options are generated for the service technician based at least in part on the list of tasks and the current geographic location of the service technician. Each of the plurality of route options includes a geographic location of at least one of the tasks in the list of tasks. The route options are output.

In addition to one or more of the features described herein, or as an alternative, further embodiments of the system may include that the operations further include determining whether a route customization was received from the service technician. In response to determining that a route customization was received from the service technician, the plurality of route options are updated based at least in part on the route customization, and the updated route options are output.

In addition to one or more of the features described herein, or as an alternative, further embodiments of the system may include that the route customization includes at least one of a preference of the service technician to perform a task on a particular day.

In addition to one or more of the features described herein, or as an alternative, further embodiments of the system may include that the route customization includes at least one of knowledge about local traffic conditions.

In addition to one or more of the features described herein, or as an alternative, further embodiments of the system may include that the route customization includes at least one of a task order preference of the service technician.

In addition to one or more of the features described herein, or as an alternative, further embodiments of the system may include that the generating a plurality of route options is further based at least in part on a route customization received from the service technician, traffic conditions, scoring factors, and a skill level of the service technician.

In addition to one or more of the features described herein, or as an alternative, further embodiments of the system may include that each of the plurality of route options further includes a score, and the operations further include calculating the score for each of the plurality of route options based at least in part on scoring factors and weights assigned to each of the scoring factors. The scoring factors include at least one of the current location of the service technician relative to a geographic location of the tasks in the route option, a number of tasks in the route option, and a priority of the tasks in the route option.

In addition to one or more of the features described herein, or as an alternative, further embodiments of the system may include that only a subset of the plurality of the route options are output, the subset selected based at least in part on the scores of each of the plurality of route options.

In addition to one or more of the features described herein, or as an alternative, further embodiments of the system may include that the operations further include receiving a selection of one of the plurality of route options from the service technician, and outputting route directions for the selected route.

In addition to one or more of the features described herein, or as an alternative, further embodiments of the system may include that the operations further include receiving a notification that task in the selected route has been completed, updating the route directions, and outputting the route directions.

In addition to one or more of the features described herein, or as an alternative, further embodiments of the system may include that the list of tasks for the service technician is based at least in part on a current geographic location of an other service technician.

In addition to one or more of the features described herein, or as an alternative, further embodiments of the system may include that the plurality of route options is further generated based on traffic conditions.

According to one embodiment a method of providing route recommendations for field service technicians is provided. The method identifying a current geographic location of a service technician and receiving a list of tasks for the service technician. The list of tasks includes, for each of the tasks, a geographic location of the task, a deadline of the task, and a priority of the task. A plurality of route options are generated for the service technician based at least in part on the list of tasks and the current geographic location of the service technician. Each of the plurality of route options includes a geographic location of at least one of the tasks in the list of tasks. The route options are output.

In addition to one or more of the features described herein, or as an alternative, further embodiments of the method may include determining whether a route customization was received from the service technician. In response to determining that a route customization was received from the service technician, the plurality of route options are updated based at least in part on the route customization, and the updated route options are output.

In addition to one or more of the features described herein, or as an alternative, further embodiments of the method may include that the route customization includes at least one of a preference of the service technician to perform a task on a particular day.

In addition to one or more of the features described herein, or as an alternative, further embodiments of the method may include that the route customization includes at least one of knowledge about local traffic conditions.

In addition to one or more of the features described herein, or as an alternative, further embodiments of the method may include that the route customization includes at least one of a task order preference of the service technician.

In addition to one or more features described herein, or as an alternative, further embodiments of the method may include that the generating a plurality of route options is further based at least in part on a route customization received from the service technician, traffic conditions, scoring factors, and a skill level of the service technician.

In addition to one or more of the features described herein, or as an alternative, further embodiments of the method may include that each of the plurality of route options further includes a score, and the method further includes calculating the score for each of the plurality of route options based at least in part on scoring factors and weights assigned to each of the scoring factors. The scoring factors include at least one of the current location of the service technician relative to a geographic location of the tasks in the route option, a number of tasks in the route option, and a priority of the tasks in the route option.

In addition to one or more of the features described herein, or as an alternative, embodiments of the method may further include receiving a selection of one of the plurality of route options from the service technician, and outputting route directions for the selected route.

Technical effects of embodiments of the present disclosure include facilitating a service technician's decisions on tasks to be performed. As technicians may have a large amount of scheduled tasks to choose from which will often be interrupted by unplanned tasks, it is a challenge for the technicians to generate an efficient service plan. Embodiments of the present disclosure provide technicians with a way to compare different options in a visual and quantitative manner, thus allowing technicians to make more informed and efficient decisions.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION

The following descriptions should not be considered limiting in any way. With reference to the accompanying drawings, like elements are numbered alike:

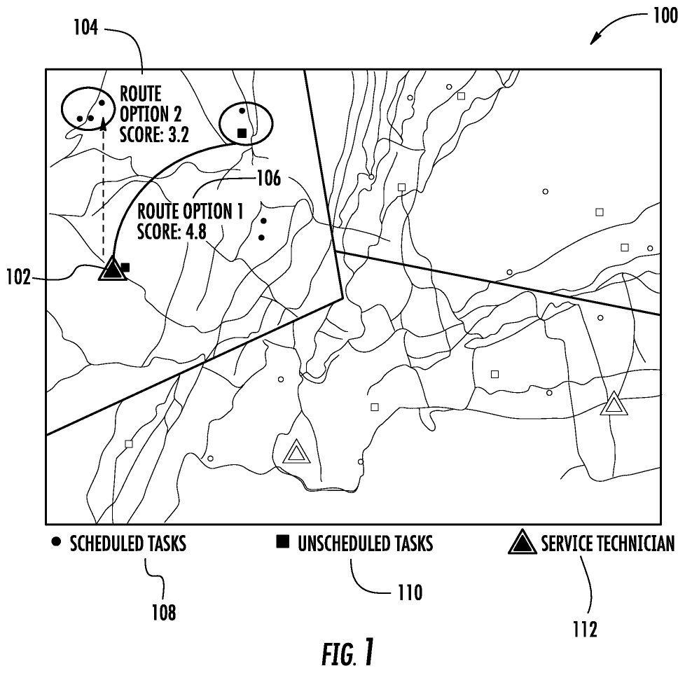

FIG. 1 is a schematic illustration of a graphical user interface (GUI) for presenting a suggested route to a field service technician in accordance with one or more embodiments of the present disclosure;

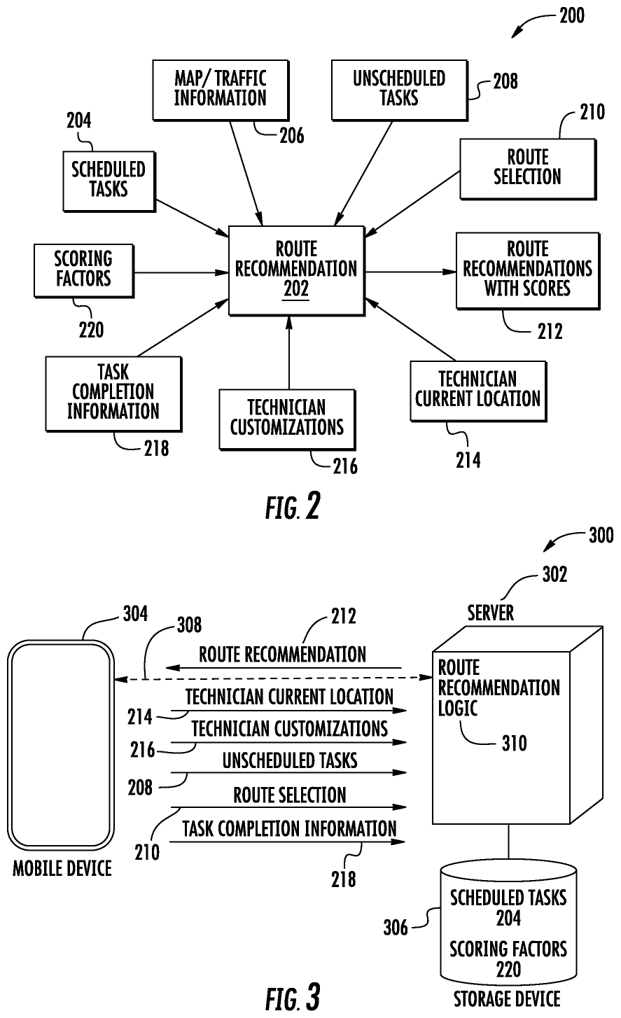

FIG. 2 is a schematic block diagram illustrating inputs to a route recommendation system for field service technicians in accordance with one or more embodiments of the present disclosure;

FIG. 3 is a schematic block diagram of a route recommendation system for field service technicians in accordance with one or more embodiments of the present disclosure; and

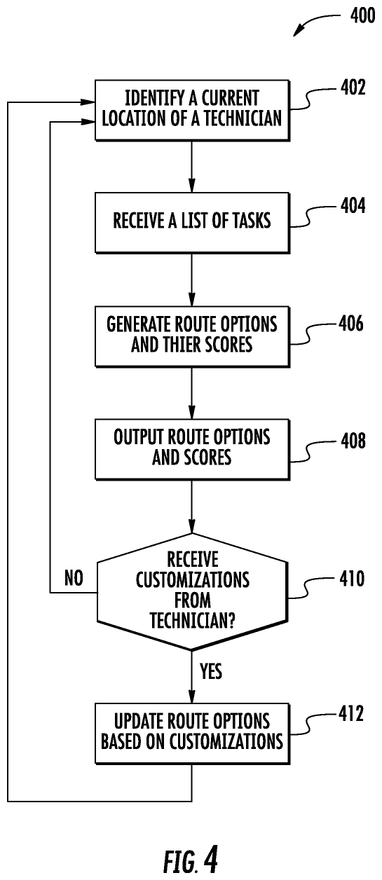

FIG. 4 is a flow diagram illustrating a method of providing a route recommendation system for field service technicians in accordance with one or more embodiments of the present disclosure.

### DETAILED DESCRIPTION

A detailed description of one or more embodiments of the disclosed apparatus and method are presented herein by way of exemplification and not limitation with reference to the Figures.

In accordance with one or more embodiments, a route recommendation system to assist field service technicians in making decisions about which service tasks to perform and an order for performing the service tasks is provided. In accordance with one or more embodiments, a graphical user interface (GUI) is displayed to technicians with tasks plotted on a map with color-coded priorities and scores of various route options. The service technician can interact with route recommendation system to customize a route.

Turning now to FIG. 1, a schematic illustration of a graphical user interface (GUI) 100 for presenting a suggested route to a field service technician is generally shown in accordance with one or more embodiments of the present disclosure. Geographic locations of scheduled tasks, both scheduled tasks 108 and unscheduled tasks 110, as well as current geographic locations of service technicians 112 are overlaid on the map shown in the GUI of FIG. 1. As used herein, the term “service technician” or “field service technician” refers to an employee who travels between different locations to perform maintenance or repair tasks. An example is a service technician for elevators who may service elevators in different locations.

As shown in FIG. 1, the recommendation system can provide multiple route options to service technicians based on factors such as, but not limited to a current location of the service technician 102, a list of service tasks to be performed, and current traffic conditions. Each route recommendation, or route option, can have a score that measures its efficiency with respect to selected criteria, or scoring factors, such as reduced travel time. As shown in FIG. 1, “Route option 1” 106 has a score of 4.8 and “Route option 2” 104 has a score of 3.2. Input from the service technicians can be used to modify the route recommendations. In this manner, a service technician can customize the recommended routes based, for example, on knowledge of local road conditions, or a longer than average service time, or preferred days for performing particular tasks. One or more embodiments of the present invention allow the service technicians to select tasks to be performed based on the recommendation system while satisfying service constraints such as required response time.

Turning now to FIG. 2, a schematic block diagram 200 illustrating inputs to a route recommendation system 202 for field service technicians is generally shown in accordance with one or more embodiments of the present disclosure. As shown in FIG. 2, scheduled tasks 204 are input to the route recommendation system 202. The input can include for example, for each scheduled task, a geographic location were the service will take place, a deadline (e.g., specific time, day, week, month, etc.) for completing the task, and a priority of the task (e.g., task to clean and elevator is lower priority than a task to fix a non-running elevator). In addition to scheduled tasks 204, unscheduled tasks 208 can also be input to the route recommendation system 202. Unscheduled tasks 208 can be tasks with a high priority that must be performed immediately (e.g., sole elevator in a busy building is not running or a person is stuck in an elevator) or tasks with a lower priority (e.g., one of several light bulbs in an elevator is not working). The high priority unscheduled tasks 208 are typically performed as soon as possible. In contrast, the lower priority unscheduled tasks 208 can be taken care of by the service provider when discovered or can be added to the scheduled tasks 204.

As shown in FIG. 2, map and traffic information 206 can also be input to the route recommendation system 202. In an embodiment the map and traffic information 206 is provided by commercially available mapping software such as, but not limited to MapQuest or Google Maps. In addition, scoring factors 220, or key performance indicators (KPIs), can also be input to the route recommendation system 202. The score of a route indicates a measurement of the efficiency of the option with respect to given KPIs. The scoring factors can include, but are not limited to: a distance between a geographic location of the service technician and a geographic location of the task; traffic conditions, task deadline, and task priority. Each of the scoring factors can be assigned a weight based on their importance. For example, the task priority can be given more weight than current traffic conditions and thus, a route that includes higher priority tasks can be assigned a higher score than a route that includes lower priority tasks.

The scoring factors and weights are used in determining a score to give to each recommended route. Both the scoring factors and the weights are customizable and may vary between implementations of the route recommendation system 202. One method of deriving the score follows in an example where a user selects two scoring factors: the percentage of non-productive travel time in total working hours and the percentage of tasks that cannot be completed before their deadlines. In this example, the user assigns the first factor with a weight of 1 and the second factor with a weight of 5. Suppose there are two route options: route one and route two. Taking route one is predicted to result in unproductive travel time of 25% and 10% of the tasks not being completed before their deadlines, while option two is predicted to result in 50% of travel time that is non-productive and all of the tasks being completed before their deadline (e.g., incomplete task 0%). In this example, option one has a score 0.25*1+0.1*5=0.75, and option two has a score 0.5*1+0*5=0.5.

Referring back to FIG. 2, task completion information 218 can be received by the route recommendation system 202, for example, from the service technician. Recommended routes of one or more service technicians can be updated based on the route recommendation system 202 being notified that a task has been completed. Another input to the route recommendation system 202 shown in the embodiment in FIG. 2 is service technician customizations 216. Service technician customizations 216 can be utilized to modify contents of route options, or route recommendation, based on service technician preferences and/or knowledge. For example, a service technician may know that a particular customer does not want non-critical service tasks to be performed on weekend days, or the service technician may have local road knowledge not reflected in the mapping software, or the service technician may expect a task to take longer or shorter than an amount of time used to create the recommended routes, or the service technician may prefer to do a particular type of service at multiple geographic locations on the same day of the week. In another example, a first technician expresses a preference to work on particular tasks of a first type and another technician expresses a preference to work on different tasks of a second type.

In an embodiment, the preferences of the technicians are taken into account by the route recommendation system 202 when assigning the tasks. In an embodiment, the skill set of and/or experience levels of the technicians are taken into account by the route recommendation system 202 when assigning the tasks. The technician customizations 216 entered by the service technician can be used to modify the recommended route options output by the route recommendation system 202. It might not be possible to find routes that meet all the technician customizations 216 however the route recommendation system 202 will attempt to meet as many as possible in the recommended routes.

Also shown in FIG. 2 is the technician current location 214 being input to the route recommendation system 202. In an embodiment, the technician has a mobile device with a geographic location tracker that sends current location of the technician to the route recommendation system 202 (e.g., periodically, when the technician moves to a new geographic location, etc.).

Route recommendations 212 including scores are output from the route recommendation system 202. In one or more embodiments, the route options are generated by advanced combinatorial optimization algorithms to select and order tasks with respect to a pre-defined objective function. For example, algorithms designed for the vehicle routing problem (VRP) can be adopted to generate route options.

One of the route recommendations can be selected when a route selection 210 is received by the route recommendation system 202. When a route is selected, the user can be presented with directions for following the selected route. In an embodiment, the system will display the listed tasks with features such as deadline, priority and expected duration. Details of the buildings that the tasks will be performed can also be displayed including customer contract information or special customer requirements. The system will also list the order in which the tasks should be performed, and a map of the task locations with up-to-date traffic conditions.

The inputs to the route recommendation system 202 are examples of the types of input that can be used to create route recommendations 212. In an embodiment, a route recommendation 212 is created using a subset of the inputs shown in FIG. 2. For example, technician customizations 216 may not be used to create a route recommendation 212. In an embodiment additional inputs are utilized to create a route recommendation 212. For example, locations of other technicians may also be input to creating a route recommendation 212 with or without technician customizations 216.

Turning now to FIG. 3, a schematic block diagram of a route recommendation system 300 for field service technicians is generally shown in accordance with one or more embodiments of the present disclosure. The route recommendation system 300 of FIG. 3 includes a mobile device 304, a server 302 including route recommendation logic 310, a storage device 306, and a network 308. Though only one mobile device 304 is shown in FIG. 3, it is contemplated that in one or more embodiments, a large number (e.g., hundreds, thousands) of service technicians will be accessing the server 302 using mobile devices 304 to retrieve route recommendations as described herein.

The server 302 and the mobile device 304 can be communicatively coupled to one another via one or more networks 308. The server 302 can be implemented as a high-speed computer processing device (e.g., a mainframe computer) capable of handling a high volume of activities conducted by the route recommendation logic 310 and the mobile device 304 with regard to the server 302. The server 302 can be operated by an enterprise or organization implementing the exemplary route recommendation logic 310 described herein. The server 302 can operate as a web server including a web site for providing access to the route recommendation logic 310. In an embodiment, the processing described herein is performed by the mobile device 304 of the field service technician.

The server 302 can also operate as an application server including one or more applications for providing the route recommendation system described herein. These one or more applications are collectively referred to herein as the route recommendation logic 310. In an embodiment, the server 302 is communicatively coupled to storage device 306, which can store scheduled tasks 204 and scoring factors 220, as well as related data used to facilitate the route recommendation system.

While the storage device 306 is shown in FIG. 3 as a separate physical device from the server 302, it will be understood that the storage device 306 can be integrated into the server 302 as internal storage (e.g., as a hard disk drive), or accessed by the server 302 via a network, or located on the mobile device 304.

The mobile device 304 may be any tool that can be interacted with by an authorized person or, in a particular case, a hand-held device and may be provided as a portable computing device, a laptop, a tablet, a smartphone, smartwatch, or a dedicated tool, such as a service tool.

The networks 308 can be any type of known networks in the art. For example, the networks 308 can be a combination of public (e.g., Internet), private (e.g., local area network, wide area network, virtual private network), and can include wireless and wireline transmission systems (e.g., satellite, cellular network, terrestrial networks, etc.). As shown in the embodiment of the route recommendation system 300 in FIG. 3, a technician current location 214, technician customizations 216, unscheduled tasks 208, a route selection 210, and task completion information 218 can be transmitted from the mobile device 304 to the server 302 via the networks 308. In an embodiment, unscheduled task information is created by/sourced from the technician's mobile device 304. In another embodiment, the unscheduled task information is from another source such as callback dispatching. Also shown in FIG. 3 is a route recommendation 212 being transmitted from the server 302 to the mobile device 304 via the networks 308.

In an embodiment, the route recommendation logic 310 can be distributed across multiple processors, for example, in the server 302 and one or more user devices mobile devices 304.

Turning now to FIG. 4, a flow diagram 400 illustrating a method of providing a route recommendation system for field service technicians is generally shown in accordance with one or more embodiments of the present disclosure. In accordance with one or more embodiments, the process flow shown in FIG. 4 is performed by the route recommendation logic 310 of FIG. 3 executing on server 302 of FIG. 3.

At block 402, a current location of a service technician is identified. In one or more embodiments, the service technician has a mobile device, such as mobile device 304 of FIG. 3, that includes location detection software, and the current geographic location of the mobile device 304 is transmitted to the route recommendation logic 310. At block 404, a list of tasks to be performed by the service technician is received by the route recommendation logic 310. The tasks can include scheduled tasks and unscheduled tasks. In one or more embodiments, the scheduled tasks are created and assigned to the service technician by task scheduling software and stored in the storage device 306 and accessed by the route recommendation logic 310. Information about each task in the list can include, but is not limited to: a geographic location of the task, a deadline of the task, and a priority of the task.

Referring back to FIG. 4, at block 406, route options for the service technician and their associated scores are generated based at least in part on contents of the list of tasks and the current geographic location of the service technician. The generating of the route options can also take into account other items such as, but not limited to: current or expected traffic conditions, grouping of particular tasks, an order of performing a group of tasks, and an estimated time to complete each task. In one or more embodiments, a score for each of the route options is calculated based at least in part on scoring factors and weights assigned to each of the scoring factors as described previously. In one or more embodiments, the scoring factors can include one or more of the current location of the service technician relative to a geographic location of the tasks in the route option, a number of tasks in the route option, and a priority of the tasks in the route option.

At block 408, the route options and scores are output, for example as the GUI 100 shown in FIG. 1. If it is determined at block 410, that customizations have not been received from the service technician, then processing continues at block 402 where a current geographic location of the service technician is identified. If it is determined at block 410, that customizations have been received from the service technician, then processing continues at block 412 where the route options are updated based on the input from the service technician, and the updated route options and scores are output at block 408. In an embodiment, block 410 also includes determining whether the service technician location has changed, and processing continues at block 412 only if it is determined that customizations have been received and the service technician location has not changed, otherwise processing continues at block 402. In one or more embodiments the route options are also updated and output in response to any of the inputs shown in FIG. 2. For example, the route options can be updated based on receiving task completion information, or in response to receiving new scheduled or unscheduled tasks, or in response to the geographic location of the service technician changing. The service technicians can apply customizations to these updated route options.

In accordance with one or more embodiments, only a subset of the route options is output to a mobile device of the service technician. The subset can include those routes having the highest scores and/or the routes that most closely match the customizations requested by the service technician. In an embodiment, two to four route options are output to the mobile device of the service technician. In other embodiments, more than four route options are output to the mobile device of the service technician.

In accordance with one or more embodiments, the list of tasks for the service technician is based at least in part on a current geographic location of another service technician. Being aware of the location of other technicians and their tasks will ensure the optimal assignment of tasks to each technician.

While the above description has described the flow process of FIG. 4 in a particular order, it should be appreciated that unless otherwise specifically required in the attached claims that the ordering of the steps may be varied.

As described above, embodiments can be in the form of processor-implemented processes and devices for practicing those processes, such as a processor. Embodiments can also be in the form of computer program code containing instructions embodied in tangible media, such as network cloud storage, SD cards, flash drives, floppy diskettes, CD ROMs, hard drives, or any other computer-readable storage medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an device for practicing the embodiments. When implemented on a general-purpose microprocessor, the computer program code segments configure the microprocessor to create specific logic circuits.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A system configured to provide route recommendations to service technicians, the system comprising:
a processor; and
a memory comprising computer-executable instructions that, when executed by the processor, cause the processor to perform operations, the operations comprising:
identifying a current geographic location of a service technician;
receiving a list of tasks for the service technician, the list comprising, for each of the tasks, a geographic location of the task, a deadline to complete the task, and a priority of the task;
generating a plurality of route options for the service technician based at least in part on the list of tasks and the current geographic location of the service technician, each of the plurality of route options comprising a geographic location of at least one of the tasks in the list of tasks; and
outputting the plurality of route options.

2. The system of claim 1, wherein the operations further comprise:
determining whether a route customization was received from the service technician;
in response to determining that a route customization was received from the service technician, updating the plurality of route options based at least in part on the route customization; and
outputting the plurality of route options in response to the updating.

3. The system of claim 2, wherein the route customization comprises at least one of a preference of the service technician to perform a task on a particular day.

4. The system of claim 2, wherein the route customization comprises at least one of knowledge about local traffic conditions.

5. The system of claim 2, wherein the route customization comprises at least one of a task order preference of the service technician.

6. The system of claim 1, wherein the generating a plurality of route options is further based at least in part on a route customization received from the service technician, traffic conditions, scoring factors, and a skill level of the service technician.

7. The system of claim 1, wherein each of the plurality of route options further comprises a score, and the operations further comprise calculating the score for each of the plurality of route options based at least in part on scoring factors and weights assigned to each of the scoring factors, the scoring factors comprising at least one of the current location of the service technician relative to a geographic location of the tasks in the route option, a number of tasks in the route option, and a priority of the tasks in the route option.

8. The system of claim 7, wherein only a subset of the plurality of the route options are output, the subset selected based at least in part on the scores of each of the plurality of route options.

9. The system of claim 1, wherein the operations further comprise:
receiving a selection of one of the plurality of route options from the service technician; and
outputting route directions for the selected route.

10. The system of claim 9, wherein the operations further comprise:
receiving a notification that task in the selected route has been completed;
updating the route directions; and
outputting the route directions.

11. The system of claim 1, wherein the list of tasks for the service technician is based at least in part on a current geographic location of an other service technician.

12. The system of claim 1, wherein the plurality of route options is further generated based on traffic conditions.

13. A method of providing route recommendations to service technicians, the method comprising:
identifying a current geographic location of a service technician;
receiving a list of tasks for the service technician, the list comprising, for each of the tasks, a geographic location of the task, a deadline to complete the task, and a priority of the task;
generating a plurality of route options for the service technician based at least in part on the list of tasks and the current geographic location of the service technician, each of the plurality of route options comprising a geographic location of at least one of the tasks in the list of tasks; and
outputting the plurality of route options.

14. The method of claim 13, further comprising:
determining whether a route customization was received from the service technician;
in response to determining that a route customization was received from the service technician, updating the plurality of route options based at least in part on the route customization; and
outputting the plurality of route options in response to the updating.

15. The method of claim 14, wherein the route customization comprises at least one of a preference of the service technician to perform a task on a particular day.

16. The method of claim 14, wherein the route customization comprises at least one of knowledge about local traffic conditions.

17. The method of claim 14, wherein the route customization comprises at least one of a task order preference of the service technician.

18. The system of claim 1, wherein the generating a plurality of route options is further based at least in part on a route customization received from the service technician, traffic conditions, scoring factors, and a skill level of the service technician.

19. The method of claim 13, wherein each of the plurality of route options further comprises a score, and the method further comprises calculating the score for each of the plurality of route options based at least in part on scoring factors and weights assigned to each of the scoring factors, the scoring factors comprising at least one of the current location of the service technician relative to a geographic location of the tasks in the route option, a number of tasks in the route option, and a priority of the tasks in the route option.

20. The method of claim 13, further comprising:
receiving a selection of one of the plurality of route options from the service technician; and
outputting route directions for the selected route.
